(19) United States
(12) Patent Application Publication
(10) Pub. No.: US 2007/0231764 A1
(43) Pub. Date: Oct. 4, 2007

(54) Equipment

(75) Inventor: Seiji Tanaka, Matsuyama-shi (JP)

Correspondence Address: BIRCH STEWART KOLASCH & BIRCH, PO BOX 747, FALLS CHURCH, VA, 22040-0747, US

(73) Assignee: Miura Co., Ltd.

(21) Appl. No.: 11/723,346

(22) Filed: Mar. 16, 2007

(30) Foreign Application Priority Data
Mar. 28, 2006 (JP) 2006-88404

(51) Int. Cl. F27D 19/00

(52) U.S. Cl. 432/41

(57) ABSTRACT

Provided is an equipment having a safety mechanism in hardware. The equipment is arranged such that a third relay (9) is controlled by a third contact driving circuit (11) as hardware so that an igniter (2) and a fuel supply valve (3) become operable when a blower is operated and a certain amount of time elapses. The equipment is arranged so as to complement drawbacks of software by the safety mechanism of hardware. The third contact driving circuit (11) is composed of a voltage multiplying rectifier circuit (27) containing a time constant circuit (13), an oscillating circuit (28) on a secondary side of the voltage multiplying rectifier circuit (27), a contact driving part (relay driving circuit) (37) on a secondary side of the oscillating circuit (28), and the like. The third relay (9) is connected to a part of the contact driving part (37).

### BACKGROUND OF THE INVENTION

1. Field of the Invention

The present invention relates to an equipment, and more specifically, to an equipment provided with a circuit system having contacts.

2. Description of the Related Art

Hereinafter, a boiler (thermal equipment) will be explained by citing as an example of an equipment. The boiler has a possibility of causing furnace explosion when it is ignited while keeping remaining unburnt gas therein. This is well known in general. Then, a so-called pre-purge of ventilating the remaining unburnt gas is carried out by actuating a blower (fan or fan motor) before starting combustion of the boiler as disclosed in JP 06-109243 A (p. 2, FIGS. 1 to 3), for example.

Control of a conventional pre-purge is carried out by control means including a CPU or a microprocessor. In other words, the control of the pre-purge is carried out by software. To be specific, the control is made to handle all processes by software such that a pre-purge time necessary for ventilating the furnace is counted with an internal timer in the software, and that the process shifts to igniting operation at a point of time when the internal timer finishes counting up the time. FIG. 4 is a flowchart showing the control of the pre-purge by the software.

In FIG. 4, when the CPU of the control means detects that pressure within the boiler has dropped and that the combustion of the boiler is necessary (Step S1), the CPU generates and outputs a driving signal for actuating the blower (Step S2). When the blower is actuated by receiving the driving signal, wind for ventilating the remaining unburnt gas is generated within the furnace. Here, there is provided a wind pressure switch that is turned on upon detection of the wind generated within the furnace, and the CPU takes in a signal indicating the on-state of the wind pressure switch. Then, when the CPU takes in the signal indicating the on-state of the wind pressure switch, a pre-purge timer, i.e., the internal timer of the CPU, starts to count up.

After that, the CPU judges whether or not the counting of the pre-purge timer is completed (Step S3). When the CPU judges that the counting of the pre-purge timer is completed, indicating that a time necessary for ventilation of the furnace has elapsed (Y in Step S3), the CPU generates and outputs a driving signal for driving an igniter and a fuel supply valve (Step S4). Receiving the driving signal, the igniter and the fuel supply valve start the igniting operation.

The conventional pre-purge control will be complementarily explained. A watchdog timer is adopted as a countermeasure against runaway of the software because every process is handled by the software. The watchdog timer is a circuit for judging that the program is operated normally while pulses are successively outputted when there is provided a process of outputting one pulse every time the program makes a round of main routines at this time and for judging that the program is in an abnormal state where the pulses stop. When it is judged that the program is in the abnormal state, when the timer forcibly sends a reset signal to the CPU.

However, in the conventional pre-purge control adopting the watchdog timer, the CPU may cause the following problems due to disturbances from the outside of the equipment, for example. That is, the CPU may run into an abnormal operation due to the disturbances or the like while successively outputting the pulses to the watchdog timer. The CPU also has a problem in that when a memory within the CPU fails, the CPU conducts the abnormal operation regardless of the output of the pulses to the watchdog timer. Beside those mentioned above, the CPU has a problem in that the program may contain a bug that induces the abnormal operation.

The inventor of the present application considers that although all of the conventional pre-purge control processes are handled by the software, a safety mechanism of hardware independent of the software or a double safety mechanism of software and hardware is necessary to control the elapse of the necessary time.

### SUMMARY OF THE INVENTION

It is an object of the present invention to provide an equipment having a safety mechanism of hardware.

The present invention has been made to achieve the above-mentioned object. According to a first aspect of the present invention, there is provided an equipment including: a first device; at least one second device; and a circuit system having a first contact, a second contact, and a third contact, in which: the circuit system has a circuit structure in which the first device on a secondary side of the first contact is operated when the first contact is turned on, and at least one second device on a secondary side of the second contact is operated when the second contact is turned on; the third contact is provided on a primary side of the second contact; and the third contact is turned on by a third contact driving circuit containing a time constant circuit.

According to the first aspect of the present invention, the third contact is turned on when the third contact driving circuit is actuated and a time corresponding to a time constant of the time constant circuit elapses. When the third contact is turned on, an electric current flows through the second contact side existing on a secondary side of the third contact, and a second device becomes operable. According to the present invention, the third contact driving circuit containing the time constant circuit is provided to control the elapse of the required time. Accordingly, the present invention provides an equipment having a structure that complements drawbacks of the software by a safety mechanism of hardware.

According to a second aspect of the present invention, in the first aspect of the present invention, the third contact driving circuit includes a voltage multiplying rectifier circuit which has the time constant circuit and to which a pulse signal is inputted, and an oscillating circuit provided on a secondary side of the voltage multiplying rectifier circuit.

According to the second aspect of the present invention, when voltage inputted from a DC power supply of the third contact driving circuit is accumulated in a capacitor, voltage of the pulse signal is added to the accumulated voltage, whereby the voltage is boosted to nearly double. After that, it is rectified by a diode and the time constant circuit and is outputted to a side of the oscillating circuit. The present invention allows the third contact driving circuit to be constructed such that the third contact existing on an output section side of the oscillating circuit is turned on only when the pulse signal is inputted and the voltage is boosted to double.

According to a third aspect of the present invention, in the first or second aspect of the present invention the first contact and the second contact are turned on based on a control signal from control means; and only turning on of the third contact is carried out by the third contact driving circuit.

According to the third aspect of the present invention, even when the control means causes an abnormal operation by receiving disturbances from the outside of the equipment, for example, it is possible to avoid the second contact from turning on and the second device from being operated because the third contact driving circuit is hardware independent of the software. Still more, the present invention allows the equipment to be constructed to suppress its cost to minimum because only the turning on of the third contact, among the plurality of types of contacts, is controlled by the safety mechanism of the hardware independent of the software.

According to a fourth aspect of the present invention, in the third aspect of the present invention a fourth contact which is turned on upon detection of operation of the first device is provided on a primary side of the third contact; and the control means monitors an on-state of the fourth contact.

According to the fourth aspect of the present invention, the third contact driving circuit becomes operable on a precondition of an operation of the first device, and the third contact is turned on when the time corresponding to the time constant of the time constant circuit elapses, whereby the second device becomes operable. According to the present invention, it becomes possible to judge that the fourth contact is causing welding when the first device is not operable and the fourth contact is turned on by monitoring on/off states of the fourth contact. Accordingly, it is possible to avoid the second device from being operated in a state where the first device is not operated.

According to a fifth aspect of the present invention, in the fourth aspect of the present invention the control signal for turning on the first contact is generated after judging by the control means that the fourth contact is in an off-state.

According to the fifth aspect of the present invention, it becomes possible to judge whether the fourth contact is causing welding before operating the first device, and to operate the first device when the fourth contact is causing no welding.

According to a sixth aspect of the present invention, in the fifth aspect of the present invention further including a second voltage multiplying rectifier circuit for multiplying and rectifying the control signal for turning on the first contact, the second voltage multiplying rectifier circuit being used as a power supply for the third contact driving circuit.

According to the sixth aspect of the present invention, the third contact driving circuit is operated on the precondition that the first device is operated by arranging such that the first device becomes operable when the fourth contact is causing no welding as described above, and that the second voltage multiplying rectifier circuit is used as a power supply for the third contact driving circuit. The third contact is turned on when the third contact driving circuit is operated and the time corresponding to the time constant of the time constant circuit elapses, whereby the second device becomes operable.

According to a seventh aspect of the present invention, there is provided an equipment, including: a first device; at least one second device; a circuit system having a first contact, a second contact, and a third contact, and control means for generating a control signal for turning on the second contact based on counting of an internal timer in software, in which: the circuit system has a circuit structure in which the first device on a secondary side of the first contact is operated when the first contact is turned on, and at least one second device on a secondary side of the second contact is operated when the second contact is turned on; the third contact is provided on a primary side of the second contact; and the third contact is turned on by a third contact driving circuit containing a time constant circuit.

According to the seventh aspect of the present invention, the third contact is turned on when the third contact driving circuit is operated and the time corresponding to the time constant of the time constant circuit elapses. When the third contact is turned on, an electric current flows through the second contact side existing on the secondary side of the third contact. At this time or after, the second device becomes operable if the internal timer in the software has completed counting up of the time. The present invention is provided with the third contact driving circuit including the time constant circuit to control the elapse of the required time. According to the present invention, even when the control means causes an abnormal operation by receiving disturbances from the outside of the equipment, it is possible to avoid the second contact from being turned on and the second device from being operated because the third contact driving circuit is hardware independent of the software.

According to an eighth aspect of the present invention, there is provided an equipment, including: a circuit structure in which a first device on a secondary side of a first contact is operated when the first contact is turned on, and at least one second device on a secondary side of the second contact is operated when the second contact is turned on; a third contact provided on a primary side of the second contact; control means for generating a control signal for turning on the third contact based on counting of an internal timer in software to turn on the third contact; and a circuit system for turning on the third contact by a third contact driving circuit containing a time constant circuit when the control means is in an abnormal state.

According to the eighth aspect of the present invention, the third contact is turned on when the third contact driving circuit is operated and the time corresponding to the time constant of the time constant circuit elapses in a case where the control means is in an abnormal state. When the third contact is turned on, an electric current flows through the second contact side existing on the secondary side of the third contact, and the second device becomes operable. The present invention is provided with the third contact driving circuit for countering with the abnormality of the control means. The present invention allows the equipment to be constructed such that the safety mechanism of hardware complements the drawbacks of software.

According to a ninth aspect of the present invention, in any one of the first to eighth aspects of the present invention, the third contact driving circuit is a fail-safe circuit.

According to the ninth aspect of the present invention, even when the third contact driving circuit fails, it is possible to positively change such failure to safety one.

According to a tenth aspect of the present invention, in any one of the first to ninth aspects of the present invention, the circuit system is used for pre-purge of a thermal equipment.

According to the tenth aspect of the present invention, there is provided a circuit system effective for pre-purge control of a thermal equipment.

According to the first and seventh aspects of the present invention, it is possible to provide the equipment having the safety mechanism of hardware.

According to the second, third, and ninth aspects of the present invention, reliability of the safety mechanism of hardware can be enhanced.

According to the fourth and fifth aspects of the present invention, reliability of the whole equipment can be enhanced.

According to the sixth aspect of the present invention, the reliability of the whole equipment and that of the safety mechanism of hardware can be enhanced.

According to the eighth aspect of the present invention, it is possible to provide the equipment having the double safety mechanism of software and hardware.

Still more, according to the tenth aspect of the present invention, it is possible to provide the thermal equipment having the circuit system effective for the pre-purge control.

### BRIEF DESCRIPTION OF THE DRAWINGS

In the accompanying drawings:

FIG. 1 is a schematic circuit diagram showing a first embodiment of the present invention;

FIG. 2 is a flowchart for explaining operations of control such as pre-purge;

FIG. 3 is a schematic circuit diagram showing a second embodiment of the present invention; and

FIG. 4 is a flowchart showing a conventional pre-purge control by means of software.

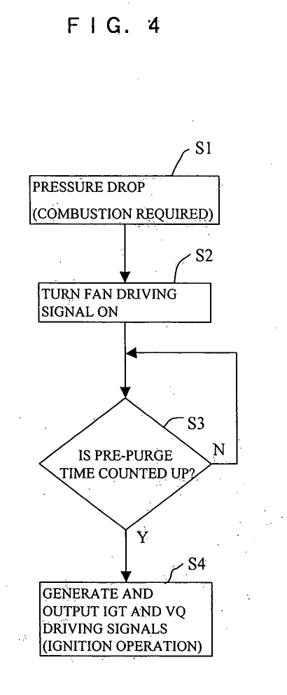

### DETAILED DESCRIPTION OF THE PREFERRED EMBODIMENTS

Next, embodiment modes for carrying out the present invention will be explained. This invention relates to an equipment, and more specifically, to an equipment provided with a circuit system having contacts. As the equipment, a thermal equipment containing various combustion controllers, such as a steam boiler and a hot water boiler maybe exemplified, though the equipment is not specifically limited to those. As the contact, known parts such as a relay and a switch are used. While the circuit system is not specifically limited, it is suitable for a pre-purge control when the equipment is the thermal equipment.

The equipment of the present invention will be explained in detail hereinafter. The equipment is constructed to control a third contact by means of hardware such that a second device becomes operable after a first device is operated and a certain amount of time elapses. The equipment of the present invention is constructed so as to complement the drawbacks of software by a safety mechanism of hardware.

A first embodiment mode for carrying out the present invention explained in detail below corresponds to Claims 1 to 6, a second embodiment mode corresponds to Claim 7, a third embodiment mode corresponds to Claim 8 and a fourth embodiment mode corresponds to Claim 10. Explanation of Claim 9 is included in the explanation of first to fourth embodiment modes.

### (First Embodiment Mode)

The equipment has a first device, one or a plurality of second devices, and a circuit system having a plurality of contacts. The first device is connected to an AC power supply. The second device is also connected to the AC power supply. A first contact is provided on a circuit between a terminal of the first device and the AC power supply. To be specific, the AC power supply exists on a primary terminal side of the first contact and the first device exists on the secondary terminal side thereof. The other terminal of the first device is connected to the AC power supply.

Second, third, and fourth contacts are provided on the circuit between a terminal of the second device and the AC power supply. To be specific, the second device exists on the secondary terminal side of the second contact. When there are two second devices, the second devices and the second contacts are configured to be in parallel. The other terminal of the second device is connected to the AC power supply. A primary terminal of the second contact is connected to a secondary terminal of the third contact. A primary terminal of the third contact is connected to a secondary terminal of the fourth contact. A primary terminal of the fourth contact is connected to the AC power supply.

The first and second contacts are turned on based on a control signal generated by control means containing a CPU or a microprocessor, though it is not specifically limited to those. That is, the control of the first and second contacts is handled by software. However, the third contact is turned on by a third contact driving circuit containing a time constant circuit. The third contact driving circuit serves as a mechanism of hardware independent of the software and composes a safety mechanism in the present invention. The fourth contact is turned on by detecting that the first device is operated. Because the fourth contact detects the operation of the first device, it has a function of a sensor here.

A connection point of the primary terminal of the third contact and the secondary terminal of the fourth contact is connected to the AC power supply via a photo-coupler circuit having a photo-coupler in the same manner as the other terminal of the first device and the other terminal of the second device. The photo-coupler is composed of light emitting elements such as light emitting diodes and light receiving elements such as photo transistors as one package. It has a character in that input/output is electrically insulated because the input signal on the side of the light emitting element and the output signal on the side of the light receiving element become optical signals on the way of becoming electrical signals.

The third contact driving circuit has the voltage multiplying rectifier circuit to which a pulse signal is inputted and contains the time constant circuit, and an oscillating circuit provided on the secondary terminal side of the voltage multiplying rectifier circuit. The voltage multiplying rectifier circuit is constructed so as to become a fail-safe circuit. The time constant circuit is composed of a resistor which causes no failure of a short-circuit, e.g., a metal film resistor, and a capacitor which causes less change of capacity, e.g., a tantalum capacitor.

The primary terminal side of the voltage multiplying rectifier circuit is connected to the photo-coupler via a buffer. The voltage multiplying rectifier circuit is constructed so as to boost voltage of the pulse signal to nearly double and to output it to the oscillating circuit via the buffer when the fourth contact is turned on and an electric current flows through the photo-coupler circuit. The voltage multiplying rectifier circuit is also constructed so as to output the voltage of the pulse signal boosted to nearly double the oscillating circuit while rectifying the voltage thereof, when a time corresponding to a time constant of the time constant circuit elapses.

The oscillating circuit is constructed as a circuit for generating continuous and constant electrical vibrations when the voltage of the pulse signal boosted to nearly double by the voltage multiplying rectifier circuit is inputted, or when voltage of a DC power supply of the voltage multiplying rectifier circuit outputted when there is no pulse signal from the buffer, i.e., voltage which is not boosted, is inputted. The third contact driving circuit is constructed so that a circuit (contact driving part) on the side of output section of the oscillating circuit turns on the third contact based on the electrical vibrations generated by the oscillating circuit when the boosted voltage is inputted.

As for the on-state of the third contact explained above, the third contact is turned on after the first device is operated and a certain amount of time elapses. The third contact is controlled by the safety mechanism of hardware.

The control means monitors voltage of the connection point. That is, when the control means detects voltage in a state where the first device is not operated, it can be seen that the fourth contact is in a welding state. When the fourth contact is in the welding state, the control means has a logic of stopping the generation of the control signal for turning on the first and second contacts. The monitoring of welding of the contacts by the control means may be performed based on the voltage of not only the fourth contact but also the secondary side of the first, second, and third contacts.

One example of the operation of the first device will be briefly explained. First, the control means confirms whether or not the fourth contact is causing welding. When it is confirmed that the fourth contact is causing no welding, the control means generates a driving pulse signal for driving the first device. The generated driving pulse signal is inputted to a driving circuit for turning on the first contact. In the driving circuit, necessary voltage is secured by causing a capacitor of a contact driving part on the circuit to repeat charge/discharge to turn on the first contact. When the first contact is turned on, the first device is operated.

The driving pulse signal may be utilized for the following operation other than driving of the first device. That is, the driving pulse signal is inputted to a second voltage multiplying rectifier circuit in addition to the driving circuit described above. Here, the second voltage multiplying rectifier circuit multiplies and rectifies voltage of the driving pulse signal to use as a power supply of the third contact driving circuit. The use of the second voltage multiplying rectifier circuit allows the third contact to be turned on by the circuit (contact driving part) on the side of the output section of the oscillating circuit based on the voltage of the driving pulse signal boosted to nearly double by the second voltage multiplying rectifier circuit and the electrical vibration generated by the oscillating circuit of the third contact driving circuit. Still more, it is possible to construct so that the third contact is not turned on when no driving pulse signal is generated and necessary power cannot be secured.

### (Second Embodiment Mode)

An equipment of this embodiment mode has basically the same structure as that of the first embodiment mode, and the third contact is turned on by the third contact driving circuit containing the time constant circuit. Similarly, the third contact driving circuit is a mechanism of hardware independent of the software and composes the safety mechanism. It is different from that of the first embodiment mode in that it is processed by the control means as follows. That is, the control means generates a control signal for turning on the second contact with respect to the second device based on counting of an internal timer in software.

In the structure described above, the third contact is turned on when the third contact driving circuit is operated and a time corresponding to a time constant of the time constant circuit elapses. When the third contact is turned on, an electric current flows through the second contact side existing on the secondary terminal side of the third contact. When the current flows through the second contact side or after, the second device is operated if the internal timer in the software has counted up the time.

Considering a case where the control means causes an abnormal operation by receiving disturbance from the outside of the equipment, for instance, the second device is prevented from being operated by turning on the second contact first because the third contact driving circuit is composed of hardware independent of the software as explained in the first embodiment mode.

### (Third Embodiment Mode)

An equipment of this embodiment mode has basically the same structure as that of the first embodiment mode. The difference from the first embodiment mode will be explained below. That is, the control means has processes of generating the control signal for turning on the third contact based on the counting of the internal timer in the software to turn on the third contact. When the control means is in the abnormal state, the third contact driving circuit is operated, and the third contact is turned on when the time corresponding to a time constant of the time constant circuit elapses. In the third embodiment mode, the third contact driving circuit is provided to counter with the abnormal state of the control means. The third contact driving circuit is a mechanism of hardware independent of software and composes the safety mechanism in the same manner. Similar hardware as the third contact driving circuit may be provided with regard to turning on of the second contact counter with the abnormal state of the control means.

### (Fourth Embodiment Mode)

A boiler as an example of the thermal equipment has a blower (first device), an igniter and a fuel supply valve (second devices), and a circuit system having a plurality of relays (contacts) Hereinafter, the present invention suitable for pre-purge control of the boiler will be explained.

The blower is connected to an AC power supply. The igniter and the fuel supply valve are also connected to the AC power supply. A first relay (first contact) is provided on a circuit between one of terminals of the blower and the AC power supply. To be specific, the AC power supply exists on the primary terminal side of the first relay and the blower exists on the secondary terminal side thereof. The other terminal of the blower is connected to the AC power supply.

A second relay (second contact), a third relay (third contact), and a wind pressure switch (fourth contact) are provided on the circuit between one of the terminals of each of the igniter and the fuel supply valve and the AC power supply. To the specific, the igniter and the fuel supply valve exist on the secondary terminal side of the second relay. The igniter, the fuel supply valve, and the second relay are configured to be in parallel. The other terminal of each of the igniter and the fuel supply valve is connected to the AC power supply. A primary terminal of the second relay is connected to a secondary terminal of the third relay. A primary terminal of the third relay is connected to a secondary terminal of the wind pressure switch. A primary terminal of the wind pressure switch is connected to the AC power supply.

The first and second relays are turned on based on a control signal generated by control means containing a CPU or a microprocessor, though it is not specifically limited. That is, the control of the first and second relays are made by software. However, the third relay is turned on by a third contact driving circuit containing a time constant circuit. The third contact driving circuit is a mechanism composed of hardware independent of the software and composes a safety mechanism in the present invention. The wind pressure switch is turned on when it detects operation of the blower. The wind pressure switch has a function of a sensor because it detects the operation of the blower.

A connection point of the primary terminal of the third relay and the secondary terminal of the wind pressure switch is connected to the AC power supply via a photo-coupler circuit having a photo-coupler in the same manner as the other terminal of each of the blower, the igniter, and the fuel supply valve. The photo-coupler is composed of light emitting elements such as light emitting diodes and light receiving elements such as phototransistors as one package. It has a character in that input/output is electrically insulated because the input signal on the side of the light emitting element and the output signal on the side of the light receiving element become optical signals on the way of becoming electrical signals.

The third contact driving circuit has the voltage multiplying rectifier circuit containing the time constant circuit and to which a pulse signal is inputted, and an oscillating circuit provided on the secondary terminal side of the voltage multiplying rectifier circuit. The voltage multiplying rectifier circuit is constructed so as to become a fail-safe circuit. The time constant circuit is composed of a resistor which causes no failure of a short-circuit, e.g., a metal film resistor, and a capacitor which causes less change of capacity, e.g., a tantalum capacitor.

The primary terminal side of the voltage multiplying rectifier circuit is connected to the photo-coupler via a buffer. The voltage multiplying rectifier circuit is constructed so as to boost voltage of the pulse signal to nearly double and to output it to the oscillating circuit via the buffer when the wind pressure switch is turned on and an electric current flows through the photo-coupler circuit. The voltage multiplying rectifier circuit is also constructed so as to output the voltage of the pulse signal boosted to nearly double to the oscillating circuit while rectifying the voltage thereof, when a time corresponding to the time constant of the time constant circuit elapses.

The oscillating circuit is constructed as a circuit for generating continuous and constant electrical vibrations when the voltage of the pulse signal boosted to nearly double by the voltage multiplying rectifier circuit is inputted, or when voltage of a DC power supply of the voltage multiplying rectifier circuit outputted when there is no pulse signal from the buffer, i.e., voltage which is not boosted, is inputted. The third contact driving circuit is constructed so that a circuit (contact driving part (relay driving circuit)), on the side of the output section of the oscillating circuit turns on the third relay based on the electrical vibrations generated by the oscillating circuit when the boosted voltage is inputted.

As for the on-state of the third relay explained above, the third relay is turned on after the blower is operated and a certain amount of time elapses. The third relay is controlled by the safety mechanism of hardware.

The control means monitors voltage of the connection point. That is, when the control means detects voltage in a state where the blower is not operated, it can be seen that the wind pressure switch is in a welding state. When the wind pressure switch is in the welding state, the control means has a logic of stopping the generation of the control signal for turning on the first and second relays. The monitoring of welding of the contacts by the control means may be performed based on the voltage of not only the wind pressure switch but also of the secondary side of the first, second, and third relays.

One example of the operation of the blower will be briefly explained. First, the control means confirms whether or not the wind pressure switch is causing welding. When it is confirmed that the wind pressure switch is causing no welding, the control means generates a driving pulse signal for driving the blower. The generated driving pulse signal is inputted to a driving circuit for turning on the first relay. In the driving circuit, necessary voltage is secured by causing a capacitor of a contact driving part on the circuit to repeat charge/discharge to turn on the first relay. When the first relay is turned on, the blower is operated. When the blower is operated, wind for ventilating remaining unburnt gas is generated within the furnace of the boiler. At this time, the boiler is in a state where the pre-purge is carried out.

The driving pulse signal may be utilized for the following operations other than driving of the blower. That is, the driving pulse signal is inputted to a second voltage multiplying rectifier circuit in addition to the driving circuit described above. Here, the second voltage multiplying rectifier circuit may multiply and rectify voltage of the driving pulse signal to use as, a power supply of the third contact driving circuit. The use of the second voltage multiplying rectifier circuit allows the third relay to be turned on by the circuit (contact driving part (relay driving circuit)) on the side of the output section of the oscillating circuit based on the voltage of the driving pulse signal boosted to nearly double by the second voltage multiplying rectifier circuit and the electrical vibration generated by the oscillating circuit of the third contact driving circuit. Still more, it is possible to construct so that the third relay is not turned on when no driving pulse signal is generated and necessary power cannot be secured.

### First Embodiment

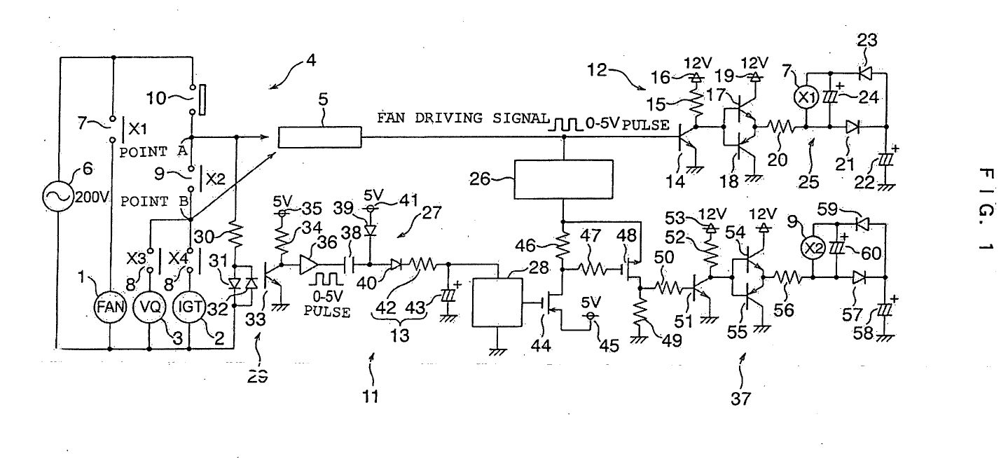

Hereinafter, an embodiment of the present invention will be explained in detail with reference to the drawings. FIG. 1 is a schematic circuit diagram showing the first embodiment of the present invention.

In FIG. 1, a boiler is composed of a blower (a fan or a fan motor; first device) 1, an igniter 2, and a fuel supply valve 3 (both of which are second devices) for carrying out pre-purge for ventilating remaining unburnt gas within a furnace and for carrying out ignition operation corresponding to a combustion request, a circuit system 4, and control means 5 for operating those mentioned above. Here, only the main components will be explained.

The blower 1, the igniter 2 and the fuel supply valve 3 are publicly known. The circuit system 4 includes an AC power supply 6, a first relay (first contact) 7, second relays (second contacts) 8, a third relay (third contact) 9, a wind pressure switch (fourth contact) 10, and a third contact driving circuit 11. The first relay 7 is denoted by reference symbol X1 in the figure. The second relays 8 are denoted by reference symbols X3 and X4 in the figure. The third relay 9 is denoted by reference symbol X2 in the figure.

Hereinafter, the boiler will be described in detail. The boiler is an equipment arranged so as to control the third relay 9 by the third contact driving circuit 11 as hardware such that the igniter 2 and the fuel supply valve 3 become operable when a certain amount of time elapses after the blower 1 is operated. The boiler is also an equipment arranged so as to complement the conventionally-concerned drawbacks of the software by a safety mechanism of hardware.

Hereinafter, each component of the circuit system 4 as well as a connection and disposition relation between the circuit system 4 and the blower 1, the igniter 2, and the fuel supply valve 3 of the circuit system 4 will be explained.

A known power supply of 200 V is used as the PC power supply 6 (all voltage within the following explanation are assumed to be the same). The blower 1, the igniter 2, and the fuel supply valve 3 are connected with the AC power supply 6, respectively. The first relay 7 is connected to a circuit between one terminal of the blower 1 and the AC power supply 6. The AC power supply 6 is connected to a primary terminal of the first relay 7, and one terminal of the blower 1 is connected to a secondary terminal of the first relay 7.

The second relays 8, the third relay 9, and the wind pressure switch 10 are connected to a circuit between one of the terminals of each of the igniter 2 and the fuel supply valve 3 and the AC power supply 6, respectively. The igniter 2 and the fuel supply valve 3 are connected to secondary terminals of the second relays 8, respectively. The igniter 2, the fuel supply valve 3, and the second relays 8 are disposed in parallel as shown in the figure.

The other terminals of the igniter 2 and the fuel supply valve 3 are connected to the AC power supply 6, respectively. Primary terminals of the second relays 8 are connected to a secondary terminal of the third relay 9 via a connection point B (point B in the figure), respectively. A primary terminal of the third relay 9 is connected with a secondary terminal of the wind pressure switch 10 via a connection point A (point A in the figure). A primary terminal of the wind pressure switch 10 is connected with the AC power supply 6. The wind pressure switch 10 is provided to detect operation of the blower 1. The wind pressure switch 10 has a function of a sensor and is set to be turned on when it detects wind generated within the furnace of the boiler.

The connection point A on the side of the primary terminal of the third relay 9 and the connection point B on the side of the secondary terminal thereof are arranged so that the control means 5monitors voltage at this position. The control means 5 is composed of a CPU or a microprocessor and executes various processes based on a processing program stored in advance. The control means 5 is provided as part of a control device for controlling the entire boiler, or may be dedicated for pre-purge or the like.

The first relay 7 and the second relays 8 are set so as to be turned on based on a control signal generated by the control means 5. In other words, the first and second relays 7 and 8 are set so that control thereof is made based on software. The control signal generated by the control means 5 is inputted to a driving circuit 12 containing the first relay 7 and a driving circuit (not shown) containing the second relays 8, respectively.

The third relay 9 is set so as to be turned on by the third contact driving circuit 11. The third contact driving circuit 11 is arranged as a mechanism of hardware independent of the software (unlike the first and second relays 7 and 8, the third relay 9 is not turned on by the software). The third contact driving circuit 11 includes a time constant circuit 13 to be described later and is arranged so as to be able to obtain an elapse of a certain amount of by the time constant circuit 13.

The driving circuit 12 for turning on the first relay 7 based on the control signal has a transistor 14. A base terminal of the transistor 14 is connected to the control means 5. The control signal outputted from the control means 5 is a pulse signal that repeats high and low levels, and is set as a FAN driving signal here. A waveform of the FAN driving signal is a rectangular wave whose voltage is 5 V at a high level and 0 V at a low level.

One terminal of a resistor 15 is connected to a collector terminal of the transistor 14. An emitter terminal of the transistor 14 is grounded. A DC power supply 16 of 12 V is connected to the other terminal of the resistor 15. A base terminal of the transistor 17 and a base terminal of a transistor 18 are connected to one terminal of the resistor 15. A DC power supply 19 of 12 V is connected to a collector terminal of the transistor 17. One terminal of a resistor 20 is connected to an emitter terminal of the transistor 17. A collector terminal of the transistor 18 is grounded. One terminal of the resistor 20 is connected to an emitter terminal of the transistor 18.

An anode terminal of a diode 21 is connected to the other terminal of the resistor 20. A plus side terminal of an electrolytic capacitor 22 is connected to a cathode terminal of the diode 21. A minus side terminal of the electrolytic capacitor 22 is grounded. An anode terminal of a diode 23 is connected to the plus side terminal of the electrolytic capacitor 22. A plus side terminal of an electrolytic capacitor 24 is connected to a cathode terminal of the diode 23. A minus side terminal of the electrolytic capacitor 24 is connected to the other terminal of the resistor 20. The first relay 7 is connected so as to be located between to the cathode terminal of the diode 23 and the other terminal of the resistor 20. As seen from the figure, a contact driving part 25 is configured so that the first relay 7 is turned on based on the FAN driving signal from the control means 5.

In the driving circuit 12, a second voltage multiplying rectifier circuit 26 is connected between a base terminal of the transistor 14 and the control means 5 (the voltage multiplying rectifier circuit 27 will be described later). The second voltage multiplying rectifier circuit 26 is identical to a known voltage multiplying rectifier circuit. When the FAN driving signal is inputted, a voltage inputted from a DC power supply of the circuit is accumulated in a capacitor and is boosted to nearly double by adding a voltage of the FAN driving signal to the accumulated voltage. After that, the boosted voltage is rectified by the diode and is outputted as a power supply on an output section side of an oscillating circuit 28 described later in the third contact driving circuit 11, i.e., as a power supply for the third contact driving circuit.

A photo-coupler circuit 29 will be explained before explaining the third contact driving circuit 11. The photo-coupler circuit 29 has a resistor 30, light emitting diodes 31 and 32, a phototransistor 33, a resistor 34, a DC power supply 35, and a buffer 36. One terminal of the resistor 30 is connected to the connection point A. An anode terminal of the light emitting diode 31 and a cathode terminal of the light emitting diode 32 are connected to the other terminal of the resistor 30. A cathode terminal of the light emitting diode 31 and an anode terminal of the light emitting diode 32 are connected to the AC power supply 6. The light emitting diodes 31 and 32 are disposed in parallel.

The phototransistor 33 is disposed in the vicinity of the light emitting diodes 31 and 32 while keeping a predetermined distance. One terminal of the resistor 34 is connected to a collector terminal of the phototransistor 33. An emitter terminal of the phototransistor 33 is grounded. The DC power supply 35 of 5 V is connected to the other terminal of the resistor 34. The buffer 36 is connected to one terminal of the resistor 34. The photo-coupler circuit 29 is arranged so that the light emitting diodes 31 and 32 emit light when the wind pressure switch 10 is turned on. The photo-coupler circuit 29 is also arranged so as to output the pulse signal to the third contact driving circuit 11 by light emitted by the light emitting diodes 31 and 32.

The pulse signal outputted to the third contact driving circuit 11 is a signal whose level repeatedly shifts between a high level and a low level. A waveform of the pulse signal is a rectangular wave whose voltage is 5 V in the high level and is 0 V in the low level.

The third contact driving circuit 11 includes the voltage multiplying rectifier circuit 27 including the time constant circuit 13, an oscillating circuit 28 on a secondary side of the voltage multiplying rectifier circuit 27, a contact driving section (relay driving circuit) 37 on an output section side of the oscillating circuit 28, and others. The third relay 9 is connected to a part of the contact driving part 37.

The voltage multiplying rectifier circuit 27 has a capacitor 38, a first diode 39, a second diode 40, and a DC power supply 41. The time constant circuit 13 contained in the voltage multiplying rectifier circuit 27 as described above has a metal film resistor 42 and a tantalum capacitor 43.

The buffer 36 of the photo-coupler circuit 29 is connected to a minus side terminal of the capacitor 38. A cathode terminal of the first diode 39 is connected to a plus side terminal of the capacitor 38. Further, an anode terminal of the second diode 40 is connected to the plus side terminal of the capacitor 38. The DC power supply 41 of 5 V is connected to an anode terminal of the first diode 39.

One terminal of the metal film resistor 42 of the time constant circuit 13 is connected to a cathode terminal of the second diode 40. A plus side terminal of the tantalum capacitor 43 of the time constant circuit 13 is connected to the other terminal of the metal film resistor 42. An input side terminal of the oscillating circuit 28 is connected to the other terminal of the metal film resistor 42. A minus side terminal of the tantalum capacitor 43 is grounded.

Here, operations of the voltage multiplying rectifier circuit 27 will be explained. First, as the operation thereof when there is the pulse signal inputted through the buffer 36, electricity is accumulated in the capacitor 38 when the voltage of the pulse signal is 0 V. The accumulation is performed from the DC power supply 41 via the first diode 39 until the voltage of the capacitor 38 becomes equal to that of the DC power supply 41. Because the DC power supply 41 is 5 V, the voltage of 5 V is accumulated in the capacitor 38 and this state is kept. When the voltage of the pulse signal is 5 V, the voltage of the capacitor 38 is boosted by adding the pulse signal of 5 V. Accordingly, the voltage of the capacitor 38 on the plus side terminal is doubled to 10 V.

When there exists the pulse signal, the voltage of the capacitor 38 on the plus side terminal becomes a voltage having a waveform synchronized with a period of the pulse signal of 5 to 10 V. The voltage of the synchronized waveform is smoothed by the second diode 40 and the time constant circuit 13 and the nearly coubled voltage of 10 V is inputted to the input section side terminal of the oscillating circuit 28. The voltage of 10 V inputted to the input section side terminal of the oscillating circuit 28 delays by a time corresponding to the time constant by the time constant circuit 13 before the input (the delay of time corresponds to an elapse of the certain amount of described above).

Next, when there exists no pulse signal, a voltage of the minus side terminal of the capacitor 38 is 0 V or 5 V. In this state, electricity is accumulated in the capacitor 38 from the DC power supply 41 via the first diode 39. The accumulation is performed until the voltage of the capacitor 38 becomes equal to that of the DC power supply 41. Because the voltage of the DC power supply 41 is 5 V, the capacitor 38 accumulates the voltage of 5 V and keeps this state.

When there exists no pulse signal, the voltage of the capacitor 38 on the minus side terminal remains to be 0 V. The voltage of the capacitor 38 on the plus side terminal is not boosted and is 5 V as a result. The voltage of 5 V is smoothed by the second diode 40 and the time constant circuit 13 and is inputted to the input section side terminal of the oscillating circuit 23 while keeping the voltage of about 5 V.

The voltage of the pulse signal boosted to nearly double to 10 V is inputted or the voltage of the DC power supply 41 of the voltage multiplying rectifier circuit 27 having no pulse signal, i.e., the voltage of 5 V not boosted, is inputted to the oscillating circuit 28. As a result, continuous and constant electrical vibration is generated and is outputted from the output section side terminal of the oscillating circuit 28.

A gate electrode of a field effect transistor (FET) 44 is connected to the output section side terminal of the oscillating circuit 28. The FET 44 is arranged so as to switch only the vibration outputted from the oscillating circuit 28 by the input of the voltage of the pulse signal boosted to 10 V (in other words, the FET 44 does not perform switching when there is no pulse signal). When the FET 44 performs switching, the contact driving section 37 becomes operable and turns on the third relay 9. A configuration of a secondary side of the FET 44 will be explained hereinafter.

A DC power supply 45 of 5 V is connected to a source electrode of the FET 44. One terminal of a resistor 46 is connected to a drain electrode of the FET 44. The second voltage multiplying rectifier circuit 26 is connected to the other terminal of the resistor 46 as a power supply for the third contact driving circuit. A gate electrode of a FET 48 is connected to one terminal of the resistor 46 via the resistor 47. The other terminal of the resistor 46 is connected to a source electrode of the FET 48. One terminal of a resistor 49 is connected to a drain electrode of the FET 48. The other terminal of the resistor 49 is grounded. A base terminal of a transistor 51 is connected to one terminal of the resistor 49 via a resistor 50.

One terminal of a resistor 52 is connected to a collector terminal of the transistor 51. An emitter terminal of the transistor 51 is grounded. A DC power supply 53 of 12 V is connected to the other terminal of the resistor 52. Abase terminal of the transistor 54 and a base terminal of a transistor 55 are connected to one terminal of the resistor 52. A DC power supply 56 of 12 V is connected to a collector terminal of the transistor 54. One terminal of a resistor 56 is connected to an emitter terminal of the transistor 54. A collector terminal of the transistor 55 is grounded. One terminal of the resistor 56 is connected to an emitter terminal of the transistor 55.

An anode terminal of a diode 57 is connected to the other terminal of the resistor 56. A plus side terminal of an electrolytic capacitor 58 is connected to a cathode terminal of the diode 57. A minus side terminal of the electrolytic capacitor 58 is grounded. An anode terminal of a diode 59 is connected to the plus side terminal of the electrolytic capacitor 58. A plus side terminal of an electrolytic capacitor 60 is connected to a cathode terminal of the diode 59. A minus side terminal of the electrolytic capacitor 60 is connected to the other terminal of the resistor 56. The third relay 9 is connected so as to be located between the cathode terminal of the diode 59 and the other terminal of the resistor 56. The third relay 9 is turned on in the third contact driving circuit 11 as hardware.

The third contact driving circuit 11 is arranged as a fail-safe circuit as apparent from the configuration described above and the figure.

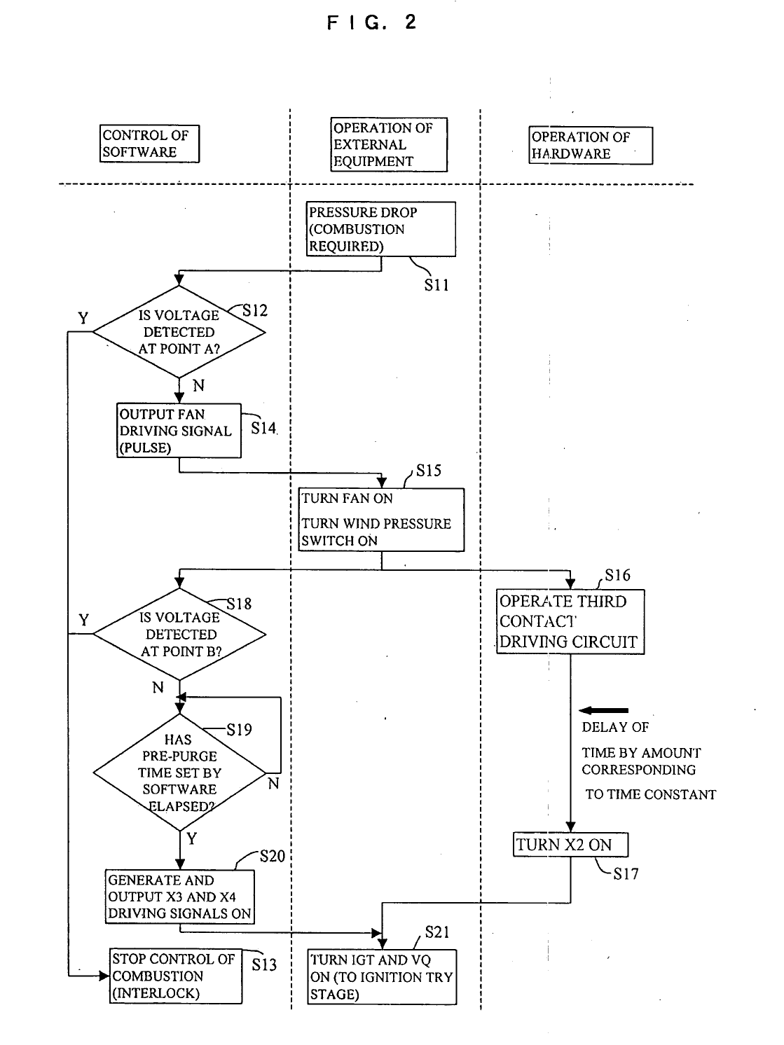

Next, operations concerning to control such a, pre-purge will be explained based on the configuration described above with reference to FIGS. 1 and 2. FIG. 2 is a flowchart for explaining the operations of the control such as the pre-purge. The flowchart of FIG. 2 shows in parallel a control flow in the software of the control means 5, an operation flow of external equipments including the blower 1, and an operation flow of the hardware concerning the circuit system 4.

When a pressure within the boiler drops and combustion of the boiler becomes necessary (Step S11), the control means 5 judges whether or not voltage is detected at the connection point A (Step S12). At this time, the blower 1 is not operated yet, so the wind pressure switch 10 detects no wind caused within the furnace of the boiler, and thus is not turned on. However, welding is caused in the wind pressure switch 10, voltage is detected at the connection point A.

When voltage is detected at the connection point A (Y in Step S12), the control means 5 shifts to a process (Step S13) of stopping (interlocking) control of combustion for the safety of the equipment. On the other hand, when no voltage is detected at the connection point A (N in Step S12), the control means 5 generates and outputs the FAN driving signal (Step S14).

The first relay 7 is turned on and the blower 1 is operated. Then, the wind pressure switch 10 detects wind caused within the furnace of the boiler and is turned on (Step S15). The light emitting diodes 31 and 32 of the photo-coupler circuit 29 in the circuit system 4 emit light and the pulse signal is inputted to the third contact driving circuit 11. Thereby, the third contact driving circuit 11 becomes operable (Step S16), the time lag occurs by the time corresponding to the time constant by the time constant circuit 13 and the third relay 9 is turned on (Step S17).

When the wind pressure switch 10 is turned on (Step S15), the control means 5 judges whether or not voltage is detected at the connection point B (Step S18). The third relay 9 is not turned on at this time, so no voltage is generated at the connection point B. However, when welding is caused in the third relay 9, voltage is detected at the connection point B.

When the voltage is detected at the connection point B (Y in Step S18), the control means 5 shifts to the process (Step S13) of stopping (interlocking) the control of combustion for the safety of the equipment. On the other hand, when no voltage is detected at the connection point B (N in Step S18), a pre-purge timer as an internal timer of the control means 5 starts counting. After that, the control means 5 judges whether or not counting of the pre-purge timer is completed (Step S19). When the control means 5 judges that counting of the pre-purge timer is completed, indicating that the necessary time has elapsed (Y in Step S19), the control means 5 generates and outputs driving signals for turning on the second relays 8 (Step S20).

When the third relay 9 is turned on (Step S17) and the second relays 8 are turned on (Step S20), the igniter 2 and the fuel supply valve 3 are operated and shift to the ignition operation (Step S21). When the third relay 9 is not turned on, it means that some abnormality has occurred. Accordingly, even when the control means 5 generates and outputs the driving signal for turning on the second relays 8, the igniter 2 and the fuel supply valve 3 are not operated. Therefore, it becomes possible to positively avoid the furnace explosion.

As described above with reference to FIGS. 1 and 2, the present invention can solve the conventional problems and provide the safe boiler.

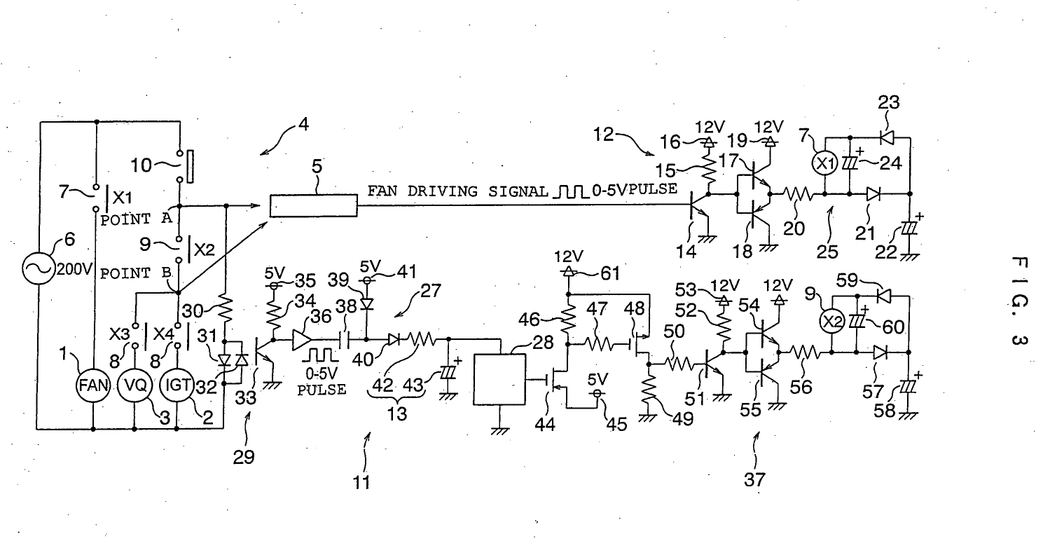

FIG. 3 is a schematic circuit diagram showing a second embodiment of the present invention.

In FIG. 3, the second embodiment is configured by removing the second voltage multiplying rectifier circuit 26 of the first embodiment (see FIG. 1) and by connecting a DC power supply 61 to the other terminal of the resistor 46 instead. While the first embodiment is arranged so as to allow the third contact driving circuit 11 to be operated by utilizing the FAN driving signal, the second embodiment is characterized in that the structure is simplified. Effects of the present invention of the second embodiment are the same as that of the first embodiment.

It is needless to say that the present invention may be variously changed without departing from the gist of the present invention.

What is claimed is:

1. An equipment, comprising:
a first device;
at least one second device; and
a circuit system having a first contact, a second contact, and a third contact, wherein:
the circuit system has a circuit structure in which the first device on a secondary side of the first contact is operated when the first contact is turned on, and at least one second device on a secondary side of the second contact is operated when the second contact is turned on;
the third contact is provided on a primary side of the second contact; and
the third contact is turned on by a third contact driving circuit containing a time constant circuit.

2. An equipment according to claim 1, wherein the third contact driving circuit comprises a voltage multiplying rectifier circuit which has the time constant circuit and to which a pulse signal is inputted, and an oscillating circuit provided on a secondary side of the voltage multiplying rectifier circuit.

3. An equipment according to claim 1 or 2, wherein:
the first contact and the second contact are turned on based on a control signal from control means; and
only turning on of the third contact is carried out by the third contact driving circuit.

4. An equipment according to claim 3, wherein:
a fourth contact which is turned on upon detection of operation of the first device is provided on a primary side of the third contact; and
the control means monitors an on-state of the fourth contact.

5. An equipment according to claim 4, wherein the control signal for turning on the first contact is generated after judging by the control means that the fourth contact is in an off-state.

6. An equipment according to claim 5, further comprising a second voltage multiplying rectifier circuit for multiplying and rectifying the control signal for turning on the first contact, the second voltage multiplying rectifier circuit being used as a power supply for the third contact driving circuit.

7. An equipment, comprising:
a first device;
at least one second device;
a circuit system having a first contact, a second contact, and a third contact; and
control means for generating a control signal for turning on the second contact based on counting of an internal timer in software, wherein:
the circuit system has a circuit structure in which the first device on a secondary side of the first contact is operated when the first contact is turned on, and at least one second device on a secondary side of the second contact is operated when the second contact is turned on;
the third contact is provided on a primary side of the second contact; and
the third contact is turned on by a third contact driving circuit containing a time constant circuit.

8. An equipment, comprising:
a circuit structure in which a first device on a secondary side of a first contact is operated when the first contact is turned on, and at least one second device on a secondary side of the second contact is operated when the second contact is turned on;
a third contact provided on a primary side of the second contact;
control means for generating a control signal for turning on the third contact based on counting of an internal timer in software to turn on the third contact; and
a circuit system for turning on the third contact by a third contact driving circuit containing a time constant circuit when the control means is in an abnormal state.

9. An equipment according to any one of claims 1 to 8, wherein the third contact driving circuit comprises a fail-safe circuit.

10. An equipment according to any one of claims 1 to 9, wherein the circuit system is used for pre-purge of a thermal equipment.
